(19) United States
(12) Patent Application Publication
(10) Pub. No.: US 2026/0138239 A1
(43) Pub. Date: May 21, 2026

(54) CLAMPING APPARATUS

(71) Applicant: Rösler Holding GmbH, Bad Staffelstein (DE)

(72) Inventors: Sven Amon, Stadelhofen (DE); Felix Bunk, Bamberg (DE); Domenik Braunroth, Coburg (DE)

(21) Appl. No.: 19/387,978

(22) Filed: Nov. 13, 2025

(30) Foreign Application Priority Data
Nov. 15, 2024 (DE) 102024133496.7

(51) Int. Cl. B25B 5/16

(52) U.S. Cl. CPC B25B 5/16

(57) ABSTRACT

A clamping apparatus has a clamping receptacle whose clamping body is permeable to powder, wherein the clamping receptacle also remains clamped against the component in the event of a volume reduction of the component.

### CROSS-REFERENCE TO RELATED APPLICATIONS

This application claims the benefit of German Application No. 102024133496.7, filed on Nov. 15, 2024. The entire disclosure of the application referenced above is incorporated herein by reference.

The invention relates to a clamping apparatus for at least one additively manufactured component for an easier handling and for a machining with at least one machining process, such as de-powdering, surface machining or cleaning in a non-de-powdered state or also in a de-powdered state.

During the machining, treatment, cleaning, de-powdering or sand removal of components in line-of-sight processes (e.g. brushing, blowing, blasting, spraying with gases, liquids, solids or combinations thereof), components are clamped and then subjected to the machining. Up to now, vices, clamping claws, collet chucks, chucks, screws or even magnetic or vacuum clamping systems, among other things, have typically been used for the clamping. In combination with the component, these systems can also be used for transferring or handling the component, for example, in zero-point clamping systems.

In the case of components additively manufactured e.g. in the powder bed process, due to adhering powder, it can occur that a component clamping is either not possible with the solutions mentioned or that manual or automated pre-processes must be carried out for the de-powdering. If the powder is not removed or is only removed insufficiently before a component clamping, the component can become loose during the machining due to the removal of the powder, whereby damage to the component and the machine can be caused.

Furthermore, when clamping thin-walled or sensitive components, damage can occur due to the clamping forces. Due to complex geometries in the case of additively manufactured components and the associated small or missing clamping surface, damage can also occur due to the occurring point load and the local overload associated therewith.

Since there is no universal clamping option for individual components, component-specific solutions adapted to the component geometry are often used. However, these complex solutions also require, for example, the prior de-powdering of the component.

During the cleaning or the de-powdering, a covering or delimiting of partial regions, at which material such as powder or blasting medium accumulates, can occur due to the clamping. Furthermore, the machining of the surface in this region is prevented, whereby the formation of so-called blast shadows can occur. On a re-clamping of the component, the material can be carried away or released again, whereby regions that have already been cleaned or machined can be contaminated again. In the case of an economically disadvantageous and a frequent manual re-clamping, there is furthermore a renewed risk of component damage due to the mechanical load.

It is therefore the object of the present invention to provide a cost-effective clamping apparatus for an additively manufactured component, with which clamping apparatus sensitive or complex components can also be handled and machined without damage.

This object is satisfied by a clamping apparatus having the features of claim 1.

The clamping apparatus according to the invention has a clamping receptacle whose clamping body is permeable to powder, wherein the clamping receptacle also remains clamped against the component by a clamping force generator in the event of a volume reduction of the component during the machining thereof.

The clamping body of the clamping receptacle is here understood as the region that serves to come into contact with the component, wherein the clamping body is not restricted to that region which actually contacts the component in the clamped state. Since, according to the invention, the clamping body is permeable to powder and also remains clamped against the component in the event of a volume reduction of the component, for example during a de-powdering process, since the clamping force generator exerts a force in the direction of the component, the component also remains clamped within the clamping apparatus in the event of a volume reduction. Due to the powder-permeable material of the clamping body, a fluid flow can be conducted through the clamping apparatus in order to release powder from the component, on the one hand. On the other hand, powder and/or blasting medium can be guided out of the clamping apparatus at the same time.

Advantageous embodiments of the invention are described in the description, in the drawing and in the dependent claims.

According to a first advantageous embodiment, the clamping force generator can be formed by the elasticity of the clamping body. In this case, the component fixing in the clamping apparatus is ensured by an inherent tension of the material of the clamping body that can, for example, comprise an elastically stretchable web material section composed of a sieve material or a net material. Due to an elastic clamping of the component with a preload, the clamping body can re-tension itself and can thus sufficiently fix one or more components that become smaller during the machining, cleaning, de-powdering or sand removal. Alternatively or additionally, the tension of the clamping body can also be applied by a clamping force generator that applies an external force to the clamping body.

According to a further advantageous embodiment, the clamping receptacle can be formed from a plurality of receiving elements that can be coupled to one another and that in particular each have a frame. For example, two frame-like receiving elements can be provided, to each of which an elastic sieve or net is attached as a clamping body. By coupling the two frames to one another, a component arranged between the two clamping bodies is then fixedly clamped but without damage. In this respect, a component can first be placed on a receiving element. The placing can take place manually or in an automated manner. The automated feeding can also take place as a direct or indirect consequence of an upstream process step.

The clamping body itself can be fastened or clamped to a holder, for example the frame. Optionally, a second receiving element is placed onto the first receiving element and the two receiving elements are connected and fixed to one another. In this respect, the clamping body can be elastically adapted to the component contour. Due to the elastic change in shape of the clamping body and the thereby resulting force effect on the component, the component is fixed.

At the clamping apparatus, a machine holder can further be present, i.e. a fastening element that serves as a receptacle for handling and fastening the clamping apparatus. Said clamping apparatus can be directly clamped in a machine, a vice or another interface by the holder or can be mounted at a further supporting structure that moves into at least one machining zone. The entire clamping apparatus can then be moved, e.g. by rotary or translatory axles, so that a machining is possible from all sides. After the machining, the component can remain in the clamping apparatus in order to undergo further machining processes or cleaning steps. Due to the clamping force, which is individually adapted to the machining situation and the component weight, a small relative movement of the component to the clamping apparatus can be ensured.

According to a further advantageous embodiment, the clamping receptacle can have at least one separating element by which at least two compartments are formed within the clamping receptacle. If a plurality of components are to be clamped in the clamping apparatus, a separating element can result in a spatial separation of the components. As a result, a contact of the components with one another is avoided, whereby the risk of damage and of overlapping (blast shadows) is reduced.

According to a further advantageous embodiment, the clamping body can have a deformable material web section, in particular a sieve and/or a (thin) wire grid composed of metal or plastic. In addition to rectilinear grid arrangements, inclined grids or honeycomb structures can also be used in this respect. The clamping bodies can, for example, be additively manufactured, cut, woven, machined, welded, joined, cast, punched or extruded and can be of a two-dimensional or three-dimensional design. Depending on the component geometry and weight, different types of grid structures or sieve structures can be used. The design and the mesh width can be suitably selected. The clamping bodies used can have a different filament thickness or strand thickness, whereby the tensioning force can be adapted to the specific case.

According to a further advantageous embodiment, the clamping body can, for example, be formed from an elastically stretchable net material. Within the nets, there can be separate wall elements or additional inserts that lead to a spatial separation of the components in order to avoid a contact of the components with one another and thus the risk of damage or overlapping.

The clamping body can in each case have individual or a plurality of nets, sieves, perforated plates and perforated films, trays with bores, perforated bags or pouches, baskets or combinations thereof. Depending on the component geometry and the shape, different types of materials can be selected for the clamping body. The material is selected such that the component is still clamped with a sufficient clamping force in the event of a de-powdering, and thus a reduction in the dimensions of the component (downsizing), and can also move slightly in the clamping receptacle in this respect. The movement of the component relative to the clamping element can in this respect correspond at least approximately to the width of the holding structure.

Alternatively, a plurality of individual elements such as threads, cords, wires, lines, perforated strips and tapes, ropes or combinations thereof can also be used as clamping bodies.

According to a further advantageous embodiment, the tension of the clamping body can be settable by an adjustment element. The tension of the clamping body can hereby be adjusted continuously or in steps, whereby the tension can be adapted to components of different sizes and weights. Different latching points can be provided at holders of the clamping body for this purpose. Using the example of a net as a clamping body, the net can be designed with tabs and hooked into latching points there.

To be able to provide specific solutions depending on the machining task, different material combinations can be used for the clamping body and the adjustment element. For example, a rigid clamping body comprising a flexible holder, an elastic clamping body comprising a rigid holder, an elastic clamping body and an elastic holder as well as a rigid clamping body and a rigid holder represent possible combinations. The component can also be clamped between rigid holders and less elastic holders. The clamping mechanism can be located outside a frame design and optionally also outside a blasting region.

According to a further advantageous embodiment, the clamping force generator can have a force source that applies an external force to the clamping body. As an alternative or in addition to an inherent elasticity of the clamping body, such an external force source can ensure that the component is clamped by the clamping body. In this case, the clamping body does not have to be elastic, but can rather be configured as a comparatively rigid sieve or rigid body (perforated plate, basket, shell), wherein the required clamping force is then provided by the external force source, for example, a spring or a drive (e.g. an actuating cylinder). In this case, two or more clamping bodies can be designed as movable relative to one another, whereby the component can be clamped, fixed or moved, or whereby an opening and a closing or an automated equipping of the apparatus becomes possible. The relative movement can be made possible by fastening and moving or actuating the clamping body or clamping bodies at movable axles, actuators, guides, cylinders, cable winches, shafts or rollers.

One or more clamping bodies can also be fastened or clamped to a holder such as a frame, to pillars, to rods, to beams, to structural stiffeners or to wires. Among other things, hook-like fastening elements can be present at the holders, whereby they pick one another up and are held together by their own weight and the weight of the component.

According to a further advantageous embodiment, the clamping force generator can cause a torsion and/or a rolling in of the clamping body. For example, the component can first be placed on a clamping body that is configured as a strip-shaped web section composed of a sieve material, a perforated film or similar. If the two ends of the strip-shaped web section are then rotated in opposite directions (for example by two motorized drives), the clamping body is twisted, whereby the component is first wrapped or rolled into the clamping body. The component is then clamped in the clamping body and can be acted on by fluid, for example. In this respect, the clamping force can be varied by the degree of torsion.

Alternatively or additionally, it is also possible in this respect to rotate the component in the clamped state by setting both drives into rotation in the same direction and synchronously, whereby a de-powdering can be brought about by the resulting centrifugal force. The machining, cleaning or de-powdering can also be supported by oscillations or vibrations. Furthermore, this leads to a slight movement of the component in the clamping element, whereby a permanent covering of identical areal regions at the component is avoided. For this purpose, a vibration motor with an imbalance weight can be mounted either at the receptacle of the apparatus or at the receptacle of the machine. In addition, the vibration excitation with piezo actuators, sound waves, etc. is also possible.

According to a further advantageous embodiment, the clamping body can be mounted at at least one movable axle, whereby the clamping receptacle can be opened and closed.

According to a further advantageous embodiment, the clamping body can have a perforated film from which in particular a web, a bag or a tube is formed. In the case of a perforated bag, the component can be placed in the bag, wherein the clamping force generator is formed by the inherent weight of the component in this case. This can be illustrated using the example of a head of lettuce that is held in a shopping bag. In this case, the weight of the head of lettuce pushes it downwards, whereby the walls of the bag cling to the head of lettuce and thereby clamp it between the walls. In the same way, a component can be held in a perforated bag, but also in a bag-shaped net, in order to clamp it therein and machine it.

In addition to rectilinear grid arrangements, inclined grids or honeycomb structures can also be used for the clamping body.

The clamping body can be designed in a two-dimensional or three-dimensional manner or can also be composed of different materials.

Strands of the clamping body can be designed as tubular or hollow at the inside and perforated and can be acted on by a fluid for cleaning or machining the component. Furthermore, the component can be moved by the escaping fluid or kept in a floating state.

The component can be partly or completely enclosed by the clamping body. The enclosure and the thereby resulting clamping can be varied by the design and the manufacture of the clamping element and can thus be adapted to one or more individual components.

Due to its preload, the clamping body can re-tension itself by utilizing the elasticity of the materials and clamping elements used and can thus also continuously and sufficiently clamp a component that becomes smaller during the machining, cleaning, de-powdering or sand removal.

The clamping body can, for example, be made of elastomers, thermoplastic elastomers, thermoplastics or fabric materials.

One or more clamping elements can be fastened or clamped to a holder such as a frame, to columns, to rods, to beams, to structural stiffeners or to wires.

A frame can have hooks, holding noses, fixing points, bolts or pins by which the tension of the clamping body can be adjusted. Bores, recesses or lugs can be present at the clamping receptacle for this purpose.

A clamping mechanism for tensioning elastic clamping bodies or for moving rigid elements outside a frame design can be located outside a blasting region or be encapsulated inside the blasting region, whereby the blasting region is also protected from blasting media and contamination.

One or more holders can perform a relative movement by a fastening and a movement or an actuation at movable axles, actuators, guides, cylinders, cable winches, shafts or rollers, whereby the component can be clamped or the opening and closing and thus a loading and unloading process with the component is made possible.

A combination of a frame and a component or of individual or a plurality of clamping receptacles and a component can be used by the receptacle as a handling and transport aid.

One or more additively manufactured, even geometrically different components can be fixed or transported in individual or a plurality of the clamping receptacles described.

The present invention will be described in the following purely by way of example with reference to advantageous embodiments and to the drawings. There are shown:

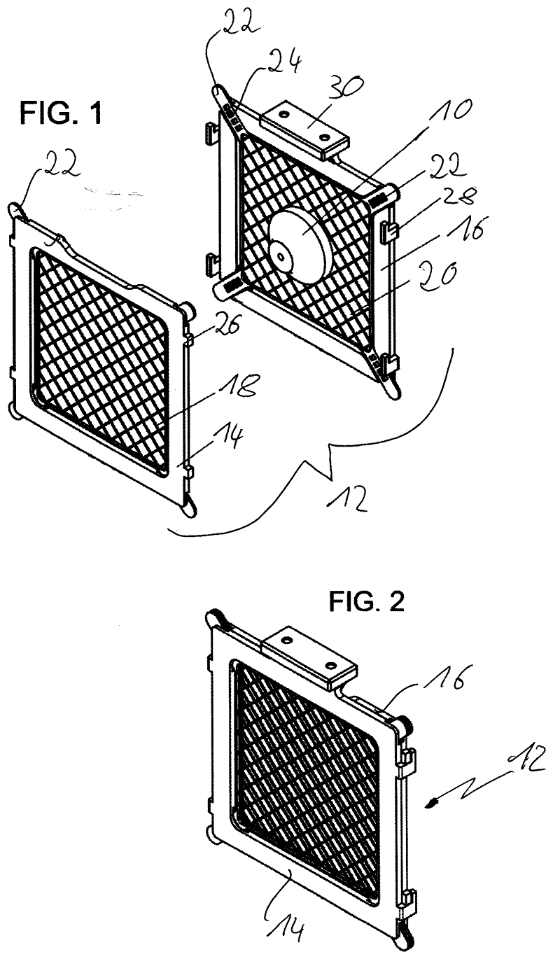

FIG. 1 a perspective exploded view of a clamping apparatus;

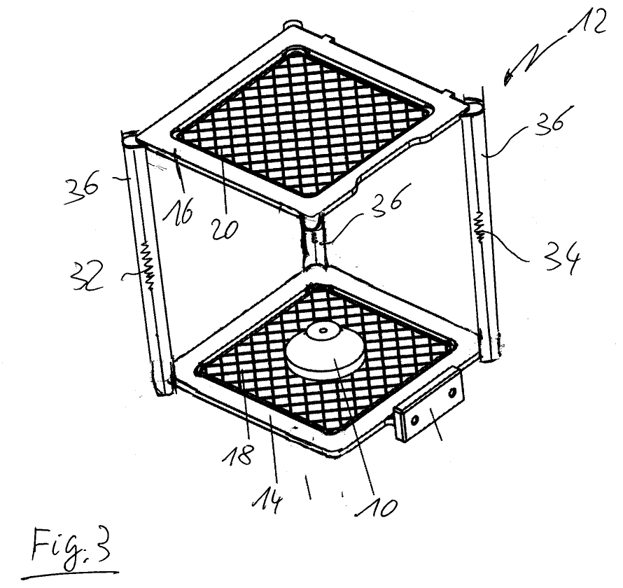

FIG. 2 the clamping apparatus of FIG. 1 in the assembled state;

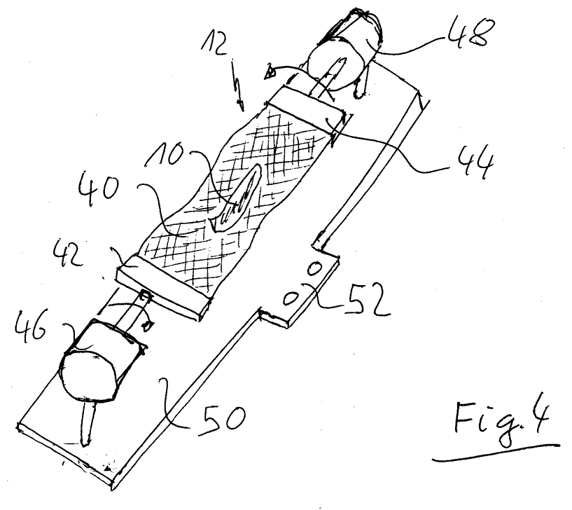

FIG. 3 a perspective view of a further embodiment of a clamping apparatus; and

FIG. 4 a further embodiment of a clamping apparatus.

FIG. 1 shows an exploded view of an apparatus for receiving, fastening, handling and machining or cleaning one or more components 10 in a non-de-powdered or de-powdered state. The clamping apparatus is also suitable for sensitive and complex components, results in little or no covering and does not require a re-clamping. The clamping apparatus shown in FIG. 1 serves to clamp at least one component 10, which is in particular additively manufactured, and, in the embodiment example shown, said clamping apparatus has a clamping receptacle 12 that is composed of two square frames 14 and 16 that can be coupled to one another in the embodiment example shown. The frames 14 and 16 can be square, which facilitates a centering of the component 10. A clamping body 18, 20 is fixed in each frame and is designed in the form of an elastic net in the embodiment example shown. In this respect, each net 18, 20 is provided with tensioning tabs 22 in the region of its corners, said tensioning tabs being hooked in at latching pins 24 of the frames 14, 16. The tension of the elastic nets 18, 20 can hereby be varied.

A coupling of the two frames 14 and 16 takes place via latching noses 26 of the frame 14 that can be hooked into latching projections 28 of the frame 16. For the clamping, the component 10 can first be placed on the net of one frame, whereupon the other frame is then placed onto the first frame and both frames are coupled to one another, whereby the state shown in FIG. 2 (without the component 10) is shown.

As FIG. 2 illustrates, a machine holder 30, with which the clamping apparatus can be held, handled and fixed in a machine, is provided at the clamping apparatus, in the embodiment example shown at the frame 16.

When a component 10 is clamped between the two clamping bodies 18 and 20 in the clamping apparatus described above, it is, however, fixedly held in the clamping apparatus without damage since the elasticity of the clamping bodies 18, 20 exerts a continuous clamping force on the component 10. If the volume of the component is reduced by de-powdering while, for example, a fluid jet is guided through the powder-permeable clamping bodies 18, 20, the component 10 remains clamped due to the elasticity of the clamping bodies 18 and 20.

FIG. 3 shows a further embodiment of a clamping apparatus for an additively manufactured component 10. In this embodiment, the clamping receptacle 12 again has two frames 14 and 16 that each fix a clamping body 18 and 20. However, in this embodiment, the clamping bodies 18 and 20 are not necessarily made of an elastic material, i.e. they can be designed as a comparatively rigid grid, sieve or the like. Here, too, the component 10 is first placed onto the lower clamping body 18, whereupon the upper clamping body 20 is lowered onto the lower clamping body. In this embodiment, gravity serves as the clamping force generator, on the one hand, and, on the other hand, the clamping force generator can have an external force source, which applies an external force to at least one clamping body, for example springs 32 and 34.

In the embodiment of FIG. 3, the upper frame 16 is guided at corners in guides 36 (the front guide is not shown for a better representation) so that the upper frame 16 can be lowered parallel to the lower frame 18. Here, too, the same advantages result as in the embodiment described above.

FIG. 4 shows a further embodiment of a clamping apparatus for an additively manufactured component 10, wherein the clamping apparatus in this embodiment has a clamping receptacle 12 whose clamping body 40 is a web-shaped section of a powder-permeable material, for example, a not necessarily elastic sieve material or net material. In the embodiment example of FIG. 4, the clamping body 40 is clamped at its two outer ends in holders 42 and 44 that can each be rotated about a common axis of rotation by a drive 46 and 48, wherein the two drives 46 and 48 are mounted on a base plate 50 that is provided with a machine holder 52.

In this embodiment, the component 10 is first placed onto the clamping body 40, whereupon the drives 46 and 48 are driven in opposite directions. The clamping body 40 hereby twists and wraps the component 10 into said clamping body in so doing. The desired tension can here be selected by the degree of twisting. The component can then be acted on by fluid through the clamping body 40. Alternatively or additionally, it is possible to set the two drives 46 and 48 into rotation in the same direction and synchronously with one another in this state so that the tension with which the component 10 is held within the clamping body 40 is maintained and powder residues can be removed from the component 10 by centrifugal force at the same time.

In all the embodiments, the clamping apparatus or the clamping receptacle 12 can be set into vibration and/or rotated for a de-powdering.

1. A clamping apparatus for at least one additively manufactured component to be machined, said clamping apparatus having a clamping receptacle whose clamping body is permeable to powder, wherein the clamping receptacle also remains clamped against the component by a clamping force generator in the event of a volume reduction of the component during the machining thereof.

2. The clamping apparatus according to claim 1,
wherein the clamping force generator is formed by the elasticity of the clamping body.

3. The clamping apparatus according to claim 1,
wherein the clamping receptacle is formed from a plurality of receiving elements that can be coupled to one another.

4. The clamping apparatus according to claim 3,
wherein the plurality of receiving elements each have a frame.

5. The clamping apparatus according to claim 1,
wherein the clamping receptacle has at least one separating element by which at least two compartments are formed within the clamping receptacle.

6. The clamping apparatus according to claim 1,
wherein the clamping receptacle is provided with at least one machine holder.

7. The clamping apparatus according to claim 1,
wherein the clamping body has a deformable material web section.

8. The clamping apparatus according to claim 7,
wherein the deformable material web section is at least one of a sieve and a grid.

9. The clamping apparatus according to claim 1,
wherein the clamping body has a net.

10. The clamping apparatus according to claim 1,
wherein the tension of the clamping body can be set by an adjustment element.

11. The clamping apparatus according to claim 1,
wherein the clamping force generator has a force source that applies an external force to the clamping body.

12. The clamping apparatus according to claim 11,
wherein the clamping force generator causes a torsion and/or a rolling in of the clamping body.

13. The clamping apparatus according to claim 1,
wherein the clamping body has a perforated film.

14. The clamping apparatus according to claim 13,
wherein one of a bag and a tube is formed from the perforated film.

15. The clamping apparatus according to claim 1,
wherein the clamping body comprises individual elements.

16. The clamping apparatus according to claim 15,
wherein the individual elements are selected from the group of members comprising threads, cords, wires, lines, perforated strips, tapes, ropes and combinations thereof.

17. The clamping apparatus according to claim 1, with an additively manufactured component arranged therein,
wherein the clamping force generator is formed by the weight of the component.

18. A method for machining an additively manufactured component, wherein the component is clamped in a clamping receptacle of a clamping apparatus, said clamping apparatus having the clamping receptacle whose clamping body is permeable to powder, wherein the clamping receptacle also remains clamped against the component by a clamping force generator in the event of a volume reduction of the component during the machining thereof and the component is acted on by a fluid jet that is guided through the powder-permeable clamping body of the clamping receptacle.

19. The method according to claim 18,
wherein the clamping receptacle is set into vibration and/or is rotated.

20. The method according to claim 18,
wherein, in order to clamp the component, the clamping body is first twisted and is then rotated in the twisted state.
